(19) United States
(12) Patent Application Publication
(10) Pub. No.: US 2014/0189165 A1
(43) Pub. Date: Jul. 3, 2014

(54) SIZE-MINIMIZED DATA LOGGER AND SECURE DIGITAL (SD) MEMORY CARD HOUSING

(71) Applicant: Precision Life Technologies, Inc., Elk Grove, CA (US)

(72) Inventor: Dongfeng ZHANG, Elk Grove, CA (US)

(73) Assignee: Precision Life Technologies, Inc., Elk Grove, CA (US)

(21) Appl. No.: 14/142,876

(22) Filed: Dec. 29, 2013

Related U.S. Application Data
(60) Provisional application No. 61/747,213, filed on Dec. 29, 2012.

(51) Int. Cl. G06F 9/44

(52) U.S. Cl. CPC G06F 9/4411
USPC 710/13

(57) ABSTRACT

Disclosed herein is a size-minimized data logger that also serves as a housing for a secure digital (SD) memory card. The SD card housing is located on one side of the data logger. The micro-SD card is used for recording raw or digital data and digitized event data. The data logger further includes, on the opposite side from the SD card housing, different functional units which are connected to one another. Exemplary functional units include an accelerometer, a magnetometer, a time unit, a temperature sensor and at least one analog/digital converter for conversion of measurement signals into digital input data, a processor unit for processing of data, a power supply source, an input interface for receiving signals or digital data and event data, and an output interface for outputting an indicator from the data logger.

### CROSS REFERENCE TO RELATED APPLICATION

The application claims priority to U.S. provisional application No. 61/747,213, filed on Dec. 29, 2012 and entitled “SIZE-MINIMIZED DATA LOGGER AND SECURE DIGITAL (SD) MEMORY CARD HOUSING,” which is hereby incorporated by reference herein in its entirety.

### FIELD OF THE INVENTION

Disclosed herein is a size-minimized data logger that also serves as a housing for a micro-secure digital (SD) memory card. The size of the overall minimized data logger is comparable to that of the micro-SD memory card and comprises a plurality of functional blocks. Also provided herein are methods for making the size-minimized data logger.

### BACKGROUND

A data logger (also known as data logger or data recorder) is an electronic device that records data over time or in relation to geographic locations. Data measurements are taken either with one or more built-in instruments or sensors or via one or more external instruments and sensors. Data loggers generally are battery powered, portable, and equipped with a microprocessor, internal memory for data storage, and sensors. Some data loggers interface with a personal computer and utilize software to activate the data logger and view and analyze the collected data, while others have a local interface device (keypad, LCD) and can be used as a stand-alone device.

General purpose type data loggers can be used in a wide range of measurement applications, while specific data loggers are dedicated for measuring data in one environment, or for one application type only. It is common for general purpose types to be programmable; however, many remain as static machines with only a limited number or no changeable parameters. Electronic data loggers have replaced chart recorder in many applications. One of the primary benefits of using data loggers is the ability to automatically collect data on a 24-hour basis. Upon activation, data loggers are typically deployed and left unattended to measure and record information for the duration of the monitoring period. This allows for a comprehensive, accurate picture of the environmental conditions being monitored, such as air temperature and relative humidity.

There is a need for size- and weight-minimized data loggers that are energy-efficient and can record permanent data over an extended period of time.

### SUMMARY OF THE INVENTION

Provided herein is a data logger comprising: a base element having two opposite sides; a housing for a memory device such as a secure digital (SD) memory card on one side of the base element, wherein a SD memory card for recording digital data is placed in the housing; and a plurality of different functional units on the other side of the base element. In some embodiments, the plurality of different functional units comprises: one or more sensors for measuring one or more types of signals; an analog-digital converter for converting raw signal measurements into digital input data; a processor unit for processing data, and a power supply source, wherein the power supply source is controlled by the removable SD memory card.

In some embodiments, the data logger further comprises an input interface for receiving measurement signals, digital data or event data.

In some embodiments, the data logger further comprises an output interface for outputting measurement signals, digital data or event data or an indicator from the data logger, wherein the indicator provides a status of the data logger.

In some embodiments, the output interface transfers measurement signals, digital data or event data or an indicator to external device such as a computer or a data reader.

In some embodiments, the data logger further comprises an a power regulator unit for regulating power supply to the data logger.

In some embodiments, the memory device comprises a removable SD memory card. In some embodiments, the memory device is permanently attached to the housing.

In some embodiments, the memory device is a standard-, mini- or micro-SD memory card. In some embodiments, the SD memory card is a micro-SD memory card.

In some embodiments, the plurality of sensors is selected from the group consisting of a speed sensor, an orientation sensor, a temperature sensor, a light sensor, a time recorder, a location sensor, and a substance detector.

In some embodiments, the plurality of sensors is selected from the group consisting of an accelerometer, a magnetometer, and a light detector. In some embodiments, the output interface comprises an LED indicator. In some embodiments, the power supply source is a rechargeable battery that is turned on when the removable micro-SD memory card is placed in the housing. In some embodiments, the power supply source is a solar-based battery that is turned on when the removable micro-SD memory card is placed in the housing. In some embodiments, the base element is a printed circuit board.

In some embodiments, the housing is formed by a micro-SD memory card connector. In some embodiments, processor unit is configured for communication with one or more functional units.

In some embodiments, the one or more functional units is selected from the group consisting of an accelerometer, a magnetometer, a crystal, and micro-SD card. In some embodiments, the SD card is used as an interface for transferring data from and to an external device. In some embodiments, the external device is a computer.

Also provided is a method for setting system parameters for the data logger, comprising: receiving, on the SD card system, a pre-compiles file comprising one or more system parameter settings. In some embodiments, the pre-compiled comprises information for setting or re-setting time, sensor data rate, measurement range, data sort, or event trigger.

In some embodiments, the pre-compiled comprises information for configuring the SD card or updating firmware for the data logger.

### BRIEF DESCRIPTION OF THE DRAWINGS

Those of skill in the art will understand that the drawings, described below, are for illustrative purposes only. The drawings are not intended to limit the scope of the present teachings in any way.

FIGS. 1A-1C illustrate a design of an exemplary minimized data logger.

FIG. 2 shows an organization chart of an exemplary minimized data logger.

FIGS. 3A and 3B illustrate sample data measured by an exemplary minimized data logger.

### DETAILED DESCRIPTION OF THE INVENTION

### Definitions

Unless otherwise noted, terms are to be understood according to conventional usage by those of ordinary skill in the relevant art.

As used herein, the term “secure digital (SD) memory card” or “SD card” encompasses any non-volatile memory card. In some embodiments, the SD memory card is a standard SD card. In this application, the terms “SD memory card” and “SD card” are used inter-changeably. In some embodiments, the SD memory card is a mini SD card. In some embodiments, the SD memory card is a micro SD card. In some embodiments, the SD card functions as a memory device. The SD card stores raw or digital date, including but not limited to time, acceleration speeds or coordinates (e.g., with respect to one or more of the standard 3 axes), magnetic strength (e.g., with respect to one or more of the standard 3 axes), temperature, or light intensities. The SD card can also store external input data, raw or digitized. In some embodiments, the SD card functions as an interface device. The SD card is removable and can be used to transfer the data to other host machine such as data signal processing computer or a PC such as a laptop.

As used herein, the term “sensor” refers to any device that can be used to collect indicia of a physical attribute; for example, measurements of motions (e.g., translational or rotational), light intensities, temperature, locations, time and etc.

As used herein, the term “housing” refers to a compartment that can be used to accommodate for example the SD memory card. In some embodiments, a large portion of the SD memory card is enclosed in the housing; for example, 40% or more, 50% or more, 60% or more, 70% or more, 80% or more, 90% or more, 95% or more. In some embodiments, the housing is formed by an SD card connector. In embodiment, housing is formed by a socket that can establish electronic connection with the SD memory card.

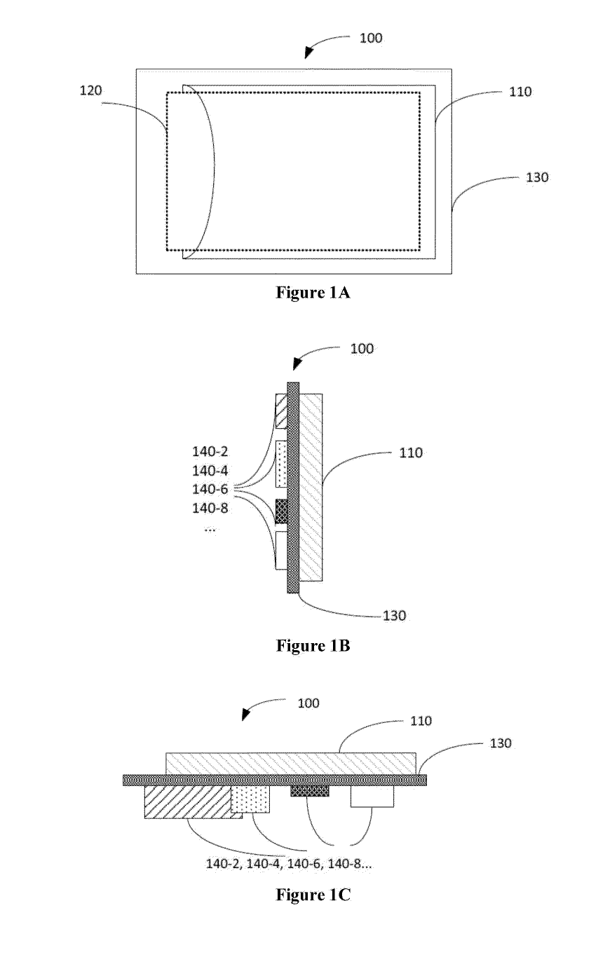

In one aspect, provided herein is a minimized data logger or module 100 that also serves as a housing 110 for a SD memory card 120 (e.g., FIGS. 1A-1C). In this application the terms data logger and module are used interchangeably. In some embodiments, the main body of the minimized data logger includes a base element 130 (e.g., a printed circuit board, PCB) that is comparable in size to a SD memory card. In some embodiments, the main body of the minimized data logger is a base element 130. On one side of the base element is a housing for a removable SD memory card. On the other side of the base element are multiple functional units (e.g., 140-2, 140-4, 140-6, 140-8 and etc.).

Any SD memory card can be used. In some embodiments, a standard SD card, (e.g., a SDHC, SDXC, or SDIO) is used. In some embodiments, a standard SD card has a length of 20 mm or more, 22 mm or more, 25 mm or more, 26 mm or more, 28 mm or more, 30 mm or more, 32 mm or more, 34 mm or more, 36 mm or more, 38 mm or more, 40 mm or more, 50 mm or more. In some embodiments, a standard SD card has a width of 10 mm or more, 12 mm or more, 15 mm or more, 16 mm or more, 18 mm or more, 20 mm or more, 22 mm or more, 24 mm or more, 26 mm or more, 28 mm or more, 30 mm or more, 40 mm or more. In some embodiments, a standard SD card has a height of 0.2 mm or more, 0.4 mm or more, 0.6 mm or more, 0.8 mm or more, 1.0 mm or more, 1.2 mm or more, 1.4 mm or more, 1.6 mm or more, 1.8 mm or more, 2.0 mm or more, 2.2 mm or more, 2.5 mm or more, 2.8 mm or more, 3.0 mm or more. In some embodiments, a standard SD card has the dimensions of 32.0×24.0×2.1 mm (1.26×0.94×0.083 in). In some embodiments, a standard SD card has the dimensions of 32.0×24.0×1.4 mm (1.26×0.94×0.055 in), with a thinner height.

In some embodiments, a mini SD card, (e.g., a miniSD, miniSDHC, miniSDIO) is used. In some embodiments, a mini SD card has a length of 10 mm or more, 12 mm or more, 15 mm or more, 16 mm or more, 18 mm or more, 20 mm or more, 22 mm or more, 24 mm or more, 26 mm or more, 28 mm or more, 30 mm or more, 40 mm or more. In some embodiments, a mini SD card has a width of 5 mm or more, 8 mm or more, 10 mm or more, 12 mm or more, 14 mm or more, 16 mm or more, 18 mm or more, 20 mm or more, 22 mm or more, 24 mm or more, 26 mm or more, 28 mm or more, 30 mm or more, 40 mm or more. In some embodiments, a mini SD card has a height of 0.2 mm or more, 0.4 mm or more, 0.6 mm or more, 0.8 mm or more, 1.0 mm or more, 1.2 mm or more, 1.4 mm or more, 1.6 mm or more, 1.8 mm or more, 2.0 mm or more, 2.2 mm or more, 2.5 mm or more, 2.8 mm or more, 3.0 mm or more. In some embodiments, a mini SD card has the dimensions of 21.5×20.0×1.4 mm (0.85×0.79×0.055 in).

In preferred embodiments, a micro-SD memory card (e.g., a microSD, microSDHC, or microSDXC) is used. In some embodiments, a micro SD card has a length of 5 mm or more, 6 mm or more, 8 mm or more, 10 mm or more, 12 mm or more, 14 mm or more, 16 mm or more, 18 mm or more, 20 mm or more, 22 mm or more, 25 mm or more, 30 mm or more. In some embodiments, a micro SD card has a width of 2 mm or more, 4 mm or more, 6 mm or more, 8 mm or more, 10 mm or more, 12 mm or more, 14 mm or more, 16 mm or more, 18 mm or more, 20 mm or more, 22 mm or more, 24 mm or more, 26 mm or more, 28 mm or more, 30 mm or more. In some embodiments, a micro SD card has a height of 0.1 mm or more, 0.2 mm or more, 0.4 mm or more, 0.6 mm or more, 0.8 mm or more, 1.0 mm or more, 1.2 mm or more, 1.4 mm or more, 1.6 mm or more, 1.8 mm or more, 2.0 mm or more, 2.2 mm or more, 2.5 mm or more, 2.8 mm or more, 3.0 mm or more. In some embodiments, the micro-SD memory card has the overall dimensions of 15.0×11.0×1.0 mm (0.59×0.43×0.039 in).

In some embodiments, the base element is a printed circuit board (PCB) having the overall dimensions that are slightly larger than those of the SD memory card.

In some embodiments, the overall dimensions of the data logger are 20×16×3.5 mm (L×W×H) when a micro-SD card is located without a battery. In some embodiments, the overall weight of the data logger is 1.6 grams including a micro-SD card.

Multiple interconnected functional units are located on the other side of the base element such as a PCB. The functional units include for example multiple sensors for measuring and/or detecting changes in speed (translation or rotational), light intensities, temperature, locations, time and etc.

Exemplary sensors include but are not limited to an accelerometer, a magnetometer, a Crystal, a photon detector, or a temperature detector. In some embodiments, a sensor is able to detect to two or more types of signals such as temperature and motions.

In some embodiments, measurements of changes in speed (translation or rotational), gravity directions, light intensities, temperature, locations are taken over an extended period of time, for example, over an hour or longer, 2 hours or longer, 3 hours or longer, 5 hours or longer, 8 hours or longer, 12 hours or longer, 18 hours or longer, 24 hours or longer, 2 days or longer, 3 days or longer, 4 days or longer, 5 days or longer, 6 days or longer, 7 days or longer, 8 days or longer, 9 days or longer, 10 days or longer, 15 days or longer, 20 days or longer, 30 days or longer, 45 days or longer, 2 months or longer, 3 months or longer, 4 months or longer, 5 months or longer, 6 months or longer, 8 months or longer, 10 months or longer, 1 year or longer.

In some embodiments, measurements of changes in speed (translation or rotational), gravity directions, light intensities, temperature, locations are taken over a set interval, from a millisecond or shorter to over a day, including but not limited to 2 milliseconds or shorter, 5 milliseconds or shorter, 10 milliseconds or shorter, 20 milliseconds or shorter, 30 milliseconds or shorter, 50 milliseconds or shorter, 100 milliseconds or shorter, 200 milliseconds or shorter, 300 milliseconds or shorter, 500 milliseconds or shorter, 750 milliseconds or shorter, 1 second or shorter, 5 seconds or shorter, 10 seconds or shorter, 1 minute or shorter, 2 minutes or shorter, 3 minutes or shorter, 4 minutes or shorter, 5 minutes or shorter, 6 minutes or shorter, 8 minutes or shorter, 12 minutes or shorter, 15 minutes or shorter, 20 minutes or shorter, 30 minutes or shorter, 45 minutes or shorter, 60 minutes or shorter. One of skill in the art would understand that the duration of the interval will be determined by the purpose of the measurements. For example, precise measurements over a short period of time will require small intervals. On the other hand, approximate measurements over a long period of time will require longer intervals.

In some embodiments, measurements will be triggered by the occurrence of a pre-determined event. The pre-determined event can be a temperature above or below a pre-set temperature limit (e.g., 25° C.), a rotational or translational speed above or below a pre-set limit, a tilt angle above or below a pre-set limit, a humidity above or below a pre-set limit, and etc.

Additional functional units include but are not limited to one or more external input units, one or more output units (e.g., an LED indicator), a power regulator, a power control, a power switch, a rechargeable battery, external charging pads, a protection circuit and a processor or processing unit.

In some embodiments, pre-collected data, raw or digital are transferred via the input units from other external devices (such as a computer) to the SD card via an SD card reader.

In some embodiments, the output unit of the minimized data logger or module 100 outputs measurement signals, digital data or event data or an indicator from the data logger.

In some embodiments, the output unit comprises an interface that communicates directly with an external device such as a computer or a data reader. In some embodiments, the interface is a USB interface. For example, minimized data logger or module 100 can be directly plugged into a computer with a USB drive. Alternatively, a USB cable can be used to connect minimized data logger or module 100 with the external computer or data reader. In some embodiments, the output unit comprises an interface through which it communicates indirectly with an external device such as a computer or a data reader. For example, data stored on minimized data logger or module 100 can be transferred wirelessly to the external device, via wireless or infrared connection.

In some embodiments, the output unit (e.g., an LED indicator) is used to indicator a status of the data logger. For example, a green LED signal indicates proper functioning of the data logger. A red LED signal indicates malfunctioning of the data logger.

As an example, a data logger can be attached to a medical or scientific equipment when the equipment is transferred between locations. During the transportation, the data logger records the tilt angel every 5 minutes. If the tilt angle is larger than a pre-determined limit (for example, 5 degrees), an LED indicator on the data logger can flash red light or play warning sounds so that adjustments can be made to ensure proper transportation. Using data loggers, the delivery process of important merchandises can be tracked, to ensure delivery quality or to monitor work efficiency.

In some embodiments, the removable SD card is used as the power control mechanism for the data logger. For example, the data logger is turned on when the SD card is placed in the housing or socket. Alternatively, the data logger is turned off when the SD card is removed from the housing or socket.

In some embodiments, the processor unit is configured for communication with the peripheral units including accelerometer, magnetometer and SD card. In some embodiments, the processor unit is configured for conversion of input data and time data into a specific format that makes the process more efficiency. In some embodiments, the processor unit is configured to embed the digital input data and time data as well as the event data as protected raw data into the generated data format such that they can be read and processed only with hardware-specific evaluation software.

Having described the invention in detail, it will be apparent that modifications, variations, and equivalent embodiments are possible without departing the scope of the invention defined in the appended claims. Furthermore, it should be appreciated that all examples in the present disclosure are provided as non-limiting examples.

### EXAMPLES

The following non-limiting examples are provided to further illustrate embodiments of the invention disclosed herein. It should be appreciated by those of skill in the art that the techniques disclosed in the examples that follow represent approaches that have been found to function well in the practice of the invention, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the invention.

### Example 1

### A Size-minimized Accelerometer Data Logger and Micro-SD Housing

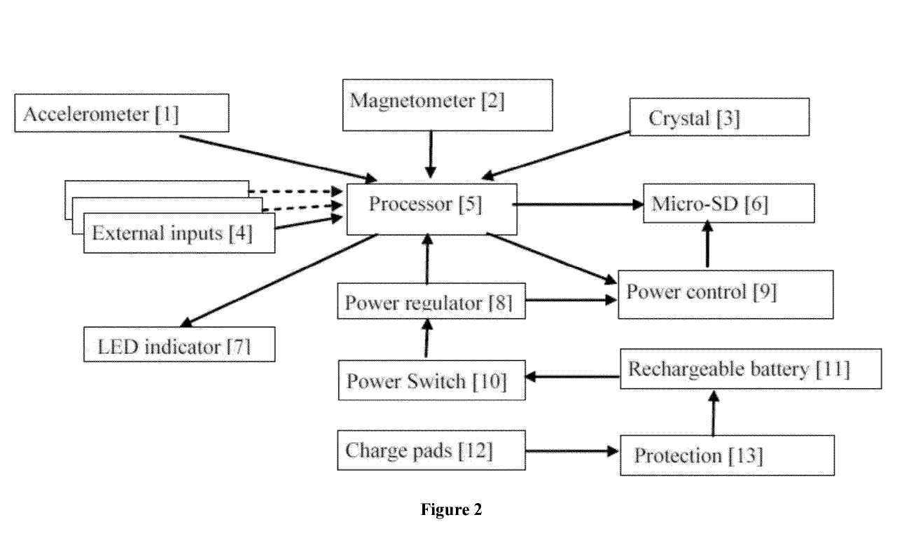

A size-minimized accelerometer data logger housing a micro-SD card was made. FIG. 2 depicts an exemplary organizational chart for the size-minimized accelerometer data logger. The size-minimized accelerometer data logger comprises a printed circuit board (PCB) as the base element. A housing for a micro-SD memory card is located on one side of the PCB. The housing is formed by a micro-SD connector. A removable micro-SD memory card [6] is placed in the housing. The micro-SD memory card functions as a memory unit for recording raw data, digital data, and digitized event data. The micro-SD memory card also functions as an interface for data transfer via external devices such as an SD card reader. Here, a micro-SD card [6] is used as the memory card. Any commercially available or custom-made micro-SD card can be used.

Multiple interconnected functional units are located on the other side of the PCB. The functional units include: accelerometer [1], magnetometer [2], Crystal [3], external inputs [4], LED indicator [7] , power regulator [8], power control [9], power switch [10], rechargeable battery [11, external charging pads [12], protection circuit [13] and processor [5].

Here, Accelerometer [1] is one of the sensors in the module for measuring proper acceleration. Magnetometer [2] is one of the sensors in the module for measuring the strength and the direction of one or more magnetic fields.

Crystal [3] is for an electronic oscillator circuit on the processor that uses the mechanical resonance of a vibrating crystal of piezoelectric material to create an electrical signal with a very precise frequency. Here, the crystal functions as a clock with better precision.

External input units [4] are used for receiving analog or digital signals from a customer. For example, a user can choose to input a data set from an external device via one of the external input units.

Processor [5] is the core of the data logger system, it process the request to transfer data from accelerometer and magnetometer, obtaining a plurality of measurements data of [1], [2], [4], insert the date and time stamp and environmental parameter (temperature) to the data sequentially, build a data stream with specific format, write it to the memory device micro-SD card. The processor monitor the peripheral devices status, it will send a variety of code to LED and drive LED flashing in order to identify status by observer.

LED [7] is used as an output unit. It is a small size light-emitting diode used as indicator lamp, which can be used to show the work status of the module, help user know the module working status.

Power regulator supply system [8] is used to stabilize or adjust a power source. Power from the battery or an external power can fluctuate significantly. It is important to regulate the power source to optimize the function of the module.

Power control [9] is a low voltage switch, which turns micro-SD card on or off It is controlled by processor.

Power switch [10] turns the entire module on or off. Here, the power switch is located in the micro-SD connector.

Rechargeable battery [11] is used to supply module power consumption. Preferably, it is Li-Polymer battery.

Charge pads [12] are two copper pads that are used for connecting external charger output to charge rechargeable battery [11].

Protect circuit [13] is used for reduce the module damage probability when a user connect an external power against rule.

### Example 2

### Using A Minimized Data Logger

Setting Time: The data logger has a time setting/reset unit. For example, prior to using the data logger, a user creates a basic SetTime.txt file by any txt editor on any computer. In the basic SetTime.txt file, the user enters in a date and time with specific format like mm/dd/yy and hour:minute:second. This time entry will be the starting time of accelerometer data logger data.

Setting Parameters: The data logger can create a parameters.txt to set the system parameters (Option 1), such as sensor data rate, measurement range, data sort, event trigger and so on.

Setting Configuration: The data logger can create a configuration.txt to set the system configuration (Option 2). For example, a user can copy a specific file such as config.rom to micro-SD card to update the firmware of the data logger or module.

The basic files such as SetTime.txt, parameters.txt, or configuration.txt can be saved to the root directory of the SD card.

The following is an illustration of an exemplary process for using the data logger.
i) Take the micro-SD card out from your micro-SD card adapter.
ii) Insert the micro-SD card into the micro-SD Adapter on the Accelerometer Data Logger module.
iii) Module power will turn on and the logger module system will check, read and execute the specific files. If it find option1 or option2 file, the logger module will set parameters or update the firmware. Then, SetTime.txt file will be read, the module will set itself starting date and time according to the content of SetTime.txt. Logger system start to working. It means that the processor start to collect data from sensors, such as accelerometer, magnetometer, temperature sensor and so on, save the data to micro-SD card after format process.
iv) A user takes the micro-SD card out from micro-SD card adapter of the module, module will be turn off automatically.
v) Copy .bin files from micro-SD card to computer, a specific format converter software will convert .bin file to a common format, for example .csv files or .txt files.

### Example 3

### Taking Measurements with A Data Logger

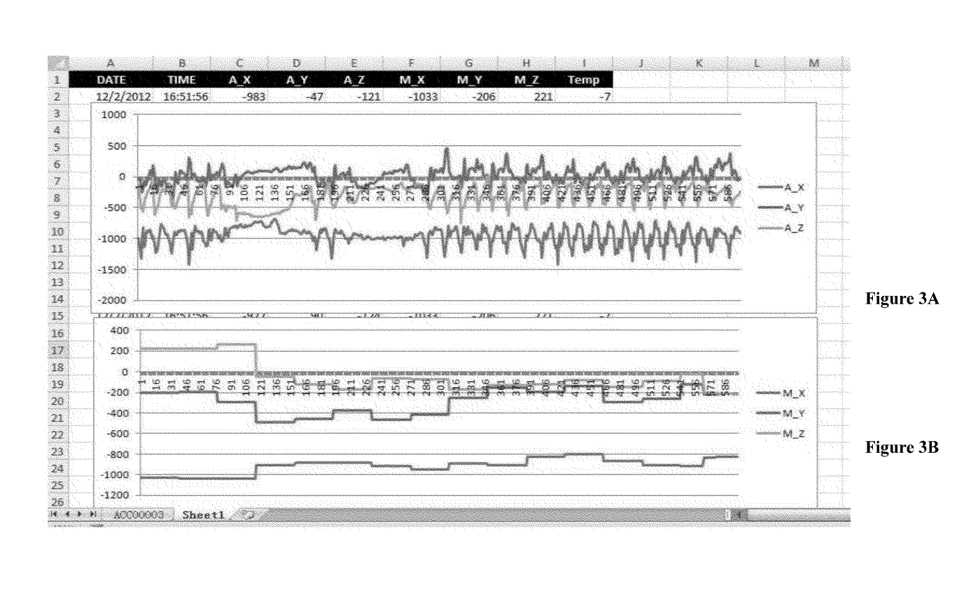

In this example, the data depicted in FIGS. 3A and 3B were collected when a man was walking. A_X, A_Y, and A_Z represent movement data on the x-axis, y-axis and z-axis as measured by an accelerometer. M_X, M_Y and M_Z represent movement data on x-axis, y-axis and z-axis as measured by a magnetometer.

The sampling rate of the accelerometer was 25 Hz. The sampling rate of the magnetometer was 0.6 Hz. Data curves were generated by excel.

The various methods and techniques described above provide a number of ways to carry out the invention. Of course, it is to be understood that not necessarily all objectives or advantages described may be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as may be taught or suggested herein. A variety of advantageous and disadvantageous alternatives are mentioned herein. It is to be understood that some preferred embodiments specifically include one, another, or several advantageous features, while others specifically exclude one, another, or several disadvantageous features, while still others specifically mitigate a present disadvantageous feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be mixed and matched by one of ordinary skill in this art to perform methods in accordance with principles described herein. Among the various elements, features, and steps some will be specifically included and others specifically excluded in diverse embodiments.

Although the invention has been disclosed in the context of certain embodiments and examples, it will be understood by those skilled in the art that the embodiments of the invention extend beyond the specifically disclosed embodiments to other alternative embodiments and/or uses and modifications and equivalents thereof.

Many variations and alternative elements have been disclosed in embodiments of the present invention. Still further variations and alternate elements will be apparent to one of skill in the art. Among these variations, without limitation, are the specific number of antigens in a screening panel or targeted by a therapeutic product, the type of antigen, the type of cancer, and the particular antigen(s) specified. Various embodiments of the invention can specifically include or exclude any of these variations or elements.

In some embodiments, the numbers expressing quantities of ingredients, properties such as molecular weight, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

In some embodiments, the terms “a” and “an” and “the” and similar references used in the context of describing a particular embodiment of the invention (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Preferred embodiments of this invention are described herein, including the best mode known to the inventors for carrying out the invention. Variations on those preferred embodiments will become apparent to those of ordinary skill in the art upon reading the foregoing description. It is contemplated that skilled artisans can employ such variations as appropriate, and the invention can be practiced otherwise than specifically described herein. Accordingly, many embodiments of this invention include all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the above cited references and printed publications are herein individually incorporated by reference in their entirety.

In closing, it is to be understood that the embodiments of the invention disclosed herein are illustrative of the principles of the present invention. Other modifications that can be employed can be within the scope of the invention. Thus, by way of example, but not of limitation, alternative configurations of the present invention can be utilized in accordance with the teachings herein. Accordingly, embodiments of the present invention are not limited to that precisely as shown and described.

1. A data logger comprising:
a base element having two opposite sides;
a housing for a secure digital (SD) memory card on one side of the base element, wherein a removable SD memory card for recording digital data is placed in the housing; and
a plurality of different functional units on the other side of the base element, wherein the plurality of different functional units comprises:
one or more sensors for measuring one or more types of signals;
an analog-digital converter for converting raw signal measurements into digital input data;
a processor unit for processing data, and
a power supply source, wherein the power supply source is controlled by the removable SD memory card.

2. The data logger of claim 1, further comprising:
an input interface for receiving measurement signals, digital data or event data.

3. The data logger of claim 1, further comprising:
an output interface for outputting measurement signals, digital data or event data or an indicator from the data logger, wherein the indicator provides a status of the data logger.

4. The data logger of claim 1, further comprising:
a power regulator unit for regulating power supply to the data logger.

5. The data logger of claim 1, wherein the SD memory card is a standard-, mini- or micro-SD memory card.

6. The data logger of claim 1, wherein the SD memory card is a micro-SD memory card.

7. The data logger of claim 1, wherein the plurality of sensors is selected from the group consisting of a speed sensor, an orientation sensor, a temperature sensor, a light sensor, a time recorder, a location sensor, and a substance detector.

8. The data logger of claim 7, wherein the plurality of sensors is selected from the group consisting of an accelerometer, a magnetometer, and a light detector.

9. The data logger of claim 3, wherein the output interface comprises an LED indicator.

10. The data logger of claim 1, wherein the power supply source is a rechargeable battery that is turned on when the removable micro-SD memory card is placed in the housing.

11. The data logger of claim 1, wherein the base element is a printed circuit board.

12. The data logger of claim 1, wherein the housing is formed by a micro-SD memory card connector.

13. The data logger of claim 1, wherein the processor unit is configured for communication with one or more functional units.

14. The data logger of claim 1, the one or more functional units is selected from the group consisting of an accelerometer, a magnetometer, a crystal, and micro-SD card.

15. The data logger of claim 1, wherein the SD card is used as an interface for transferring data from and to an external device.

16. The data logger of claim 15, wherein the external device is a computer.

17. A method for setting system parameters for the data logger of claim 1, comprising: receiving, on the SD card system, a pre-compiles file comprising one or more system parameter settings.

18. The method of claim 17, wherein the pre-compiled comprises information for setting or resetting time, sensor data rate, measurement range, data sort, or event trigger.

19. The method of claim 17, wherein the pre-compiled comprises information for configuring the SD card or updating firmware for the data logger.
